(19) United States
(12) Patent Application Publication
(10) Pub. No.: US 2009/0270162 A1
(43) Pub. Date: Oct. 29, 2009

(54) GAMING SYSTEM AND A METHOD OF GAMING

(75) Inventor: Hyong Joo Kim, Meadowbank (AU)

Correspondence Address: HANLEY, FLIGHT & ZIMMERMAN, LLC, 150 S. WACKER DRIVE, SUITE 2100, CHICAGO, IL, 60606, US

(73) Assignee: Aristocrat Technologies Australia Pty Limited, Lane Cove (AU)

(21) Appl. No.: 12/265,816

(22) Filed: Nov. 6, 2008

(30) Foreign Application Priority Data
Nov. 6, 2007 (AU) 2007906079

(51) Int. Cl. A63F 9/24; A63F 13/00

(52) U.S. Cl. 463/20; 463/30; 463/43

(57) ABSTRACT

Certain embodiments relate to a gaming system which is arranged to generate a feature game utilizing a display of a number of inputs, a number of outputs and a number of displayed paths between them. The displayed paths in the game may not be displayed until the player has selected an input. The paths may be displayed in the form of a ladder representation, with uprights and rungs, connecting an input to an output. The ladder may be revealed progressively or when the player selects the input.

### CROSS-REFERENCE TO RELATED APPLICATIONS

The present application claims the benefit of priority to Australian Provisional Patent Application No. 2007906079, filed on Nov. 6, 2007, entitled “A GAMING SYSTEM AND A METHOD OF GAMING”, which is herein incorporated by reference in its entirety.

### FIELD OF THE INVENTION

The present invention relates to a gaming system and a method of gaming.

### BACKGROUND OF THE INVENTION

It is known to provide a gaming system which comprises a game controller arranged to control the random display of several symbols from a pre-determined set of symbols and to determine a game outcome such as a game win, based on the displayed symbols. Such gaming systems may commonly be implemented as a stepper machine provided with reels, with each reel carrying several symbols of the set, or a video machine wherein selected symbols are displayed on virtual reels on a graphical display device. “Win” or other outcomes can occur based on symbols appearing on one or more horizontal lines, diagonal lines, or in any other predetermined way.

It is known to provide gaming systems where a game controller controls play of a base game (which may determine a game outcome based on selection from a pre-determined set of symbols) and a feature game. A feature game may be generated as a result of a game outcome of the base game. For example, a feature game may comprise one or more “free games” based on a pre-determined combination of symbols occurring as a result of play of a base game, or some other pre-determined criterion.

While such gaming systems provide users with enjoyment, a need exists for alternative gaming systems in order to maintain or increase player enjoyment.

### SUMMARY OF THE INVENTION

In accordance with a first aspect, the present invention provides a gaming system, including

a display, a game controller arranged to determine an outcome of a base game, and a feature game generator arranged to control play of a feature game, the feature game generator being arranged to determine a feature game outcome, and being arranged to control the display to display a representation of a feature game input and feature game outcome, and a path between the feature game input and outcome.

In an embodiment, the feature game generator is arranged to select the feature game outcome from a plurality of available feature game outcomes and to control the display to display representations for the plurality of feature game outcomes.

In an embodiment, the feature game generator is arranged to enable a selection of a feature game input from a plurality of feature game inputs available for selection, and to control the display to display representations of the plurality of feature game inputs.

In an embodiment, the feature game generator is arranged to control display of a plurality of paths connecting each input with a respective outcome. The paths may be represented as a “ladder game” format. In a ladder game format the paths are presented as a number of ladders having risers and rungs. The rungs may be horizontal or may be off horizontal and the risers may be vertical or off vertical. The bottom end of each ladder riser represents a game input. Where there are a plurality of game inputs (represented as the bottom ends of each of a plurality of ladder risers) a player or the feature game generator may select one of the inputs. The ladder game is then played by “climbing” the ladder from the selected input. Each time a join between a rung or riser is reached, progress of the path switches along the rung or riser that leaves away from the join towards the outcome. In this embodiment, for each input there is a unique outcome. In an embodiment, progress of the path may be determined by player input. For example, the player may be able to determine which direction from rung or riser (or any path if the embodiment is not one which is not represented by a ladder) to take.

In an embodiment, the feature game is arranged to control display of the paths such that the path is only revealed after a selection of the feature game input has been made. That way, the player does not get to be able to trace the path to the output before making a selection (or before the feature game generator gets to make the selection) of an input. In an embodiment, the feature game generator is arranged to control display of the path such that the path is progressively revealed.

In an embodiment, the feature game generator is arranged to control the display to display a graphical character moving along the path. The graphical character may be any character e.g. a representation of an animal, a human-being, a cartoon character or any other character.

Achieving the outcome of a feature game may result in awarding of a prize, such as a multiplier of a base game outcome, a jackpot, or any other prize.

Providing a feature game where an input may be selected and a path revealed to an output which awards a prize, may provide an entertaining variation in game play.

In an embodiment, the game controller includes a symbol selector arranged to select a plurality of symbols from a set of symbols, and an outcome generator which is arranged to determine a base game outcome based on the selected symbols. The symbols may be displayed on reels, either mechanical or video or any other type of reel.

In accordance with a second aspect, the present invention provides a method of gaming, including the steps of playing a base game;

playing a feature game having a feature game outcome, and displaying a representation of a feature game input and feature game outcome, and a path between the feature game input and outcome.

In an embodiment, the step of playing the feature game includes the step of selecting the feature game outcome from a plurality of available feature game outcomes, and the step of displaying a representation includes the step of displaying representations for the plurality of feature game outcomes.

In an embodiment, the step of playing the feature game includes the step of enabling selection of the feature game input from a plurality of feature game inputs available for selection, and the step of displaying a representation includes the step of displaying representations of the plurality of feature game inputs.

In the embodiment where there are a plurality of inputs and a plurality of outputs, the step of displaying the representation may include the step of displaying a plurality of paths connecting each input with a respective outcome. In an embodiment, the displayed paths are represented as a ladder game format.

In an embodiment, the step of displaying a representation includes the step of displaying the paths such that the paths are only revealed after a selection of the feature game input has been made. In an embodiment, the step of displaying a representation includes the step of displaying the pathway such that the path is progressively revealed.

In an embodiment, the step of displaying the representation includes the step of displaying a graphical character moving along the path.

The above aspects of the invention relate to play of a feature game. The system and method involve the play of a base game and one or more outcomes of the base game may result in playing of the feature game which involves display of a feature game input, outcome and path between the feature game input and outcome. This type of game is not limited to being played as a feature game. The “path” game may be a base game, and embodiments of the present invention encompass playing this game as a game in its own right.

In accordance with a third aspect, the present invention provides a gaming system, including

a display,

and a game controller arranged to control play of a game, the game controller being arranged to determine a game outcome, and being arranged to control the display to display a representation of a game input and a game outcome, and a path between the game input and outcome.

The game of this third aspect of the invention may have any or all of the features of the feature game of the first and second aspects of the invention.

In accordance with a fourth aspect, the present invention provides a method of gaming, including steps of;

playing a game having a game outcome, and displaying a representation of game input and a game outcome, and a path between the game input and outcome.

The game of this aspect of the invention may have any or all of the features of the feature game of the first and second aspects of the invention.

In accordance with a fifth aspect, the present invention provides a computer program, including instructions for controlling a computer to implement a system in accordance with the first aspect of the invention.

In accordance with a sixth aspect, the present invention provides a computer readable medium, providing a computer program in accordance with the fifth aspect of the invention.

In accordance with a seventh aspect, the present invention provides a computer program, including instructions for controlling a computer to implement a system in accordance with the third aspect of the invention.

In accordance with an eighth aspect, the present invention provides a computer readable medium, providing a computer program in accordance with the seventh aspect of the invention.

### BRIEF DESCRIPTION OF THE DRAWINGS

Features and advantages of the present invention will become apparent from the following description of certain embodiments thereof, by way of example only, with reference to the accompanying drawings, in which:

FIG. 1 is a schematic block diagram of core components of a gaming system in accordance with an embodiment of the present invention;

FIG. 2 is a diagrammatic representation of a gaming system in accordance with an embodiment of the present invention with the gaming system implemented in the form of a stand alone gaming machine;

FIG. 3 is a schematic block diagram of operative components of the gaming machine shown in FIG. 2;

FIG. 4 is a schematic block diagram of components of a memory of the gaming machine shown in FIG. 2;

FIG. 5 is a schematic diagram of a gaming system in accordance with an alternative embodiment of the present invention with the gaming system implemented over a network;

FIG. 6 is a schematic diagram of functional components of a gaming system in accordance with an embodiment of the present invention;

FIG. 7 through 11 are representations of sample displays generated by a gaming system in accordance with embodiments of the present invention; and

FIG. 12 is a flow diagram illustrating operation of a gaming system in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF EMBODIMENTS

Referring to the drawings, there are shown example embodiments of gaming systems which are arranged to implement a game have a game outcome and in which a representation is displayed of a game input and game outcome and a path between the game input and outcome. In this example embodiment, there are a plurality of inputs and a plurality of outcomes and paths connecting the inputs to the respective outcomes. In this example, the paths are represented in a ladder game format. In one described embodiment, the game is played as a feature game generated as a result of an outcome of a base game. In another embodiment, the game is a game in itself, not a feature. The gaming system may take a number of different forms.

In a first form, a stand alone gaming machine is provided wherein all or most components for implementing the game are present in a player operable gaming machine.

In a second form, a distributed architecture is provided wherein some of the components for implementing the game are present in a player operable gaming machine and some of the components for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

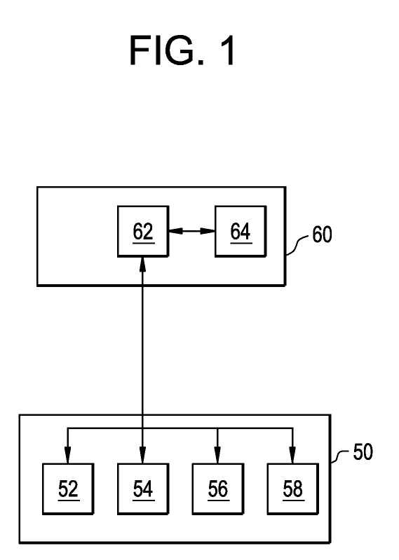

Irrespective of the form, the gaming system includes several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions and play the game.

Components of the player interface may vary from embodiment to embodiment but will typically include a credit mechanism 52 to enable a player to input credits and receive payouts, one or more displays 54 and a game play mechanism 56 that enables a player to input game play instructions.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

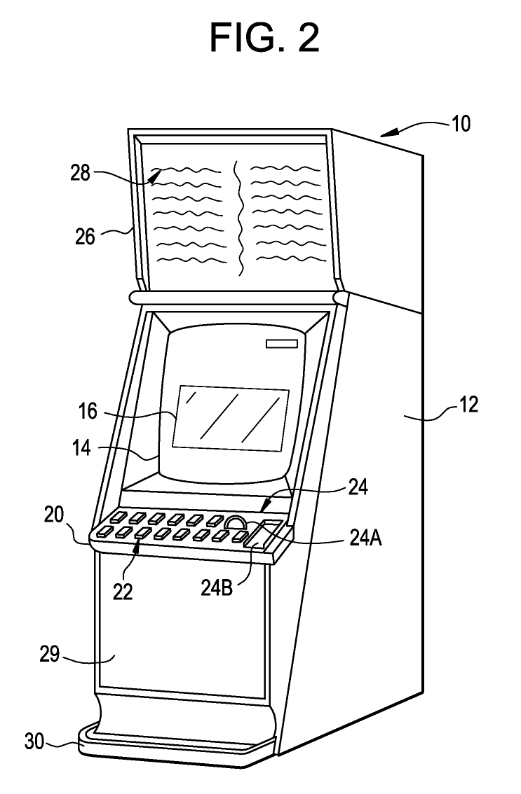

A gaming system in the form of a stand alone gaming machine 10 is illustrated in FIG. 2. The gaming machine 10 includes a console 12 having a display 14 on which is displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

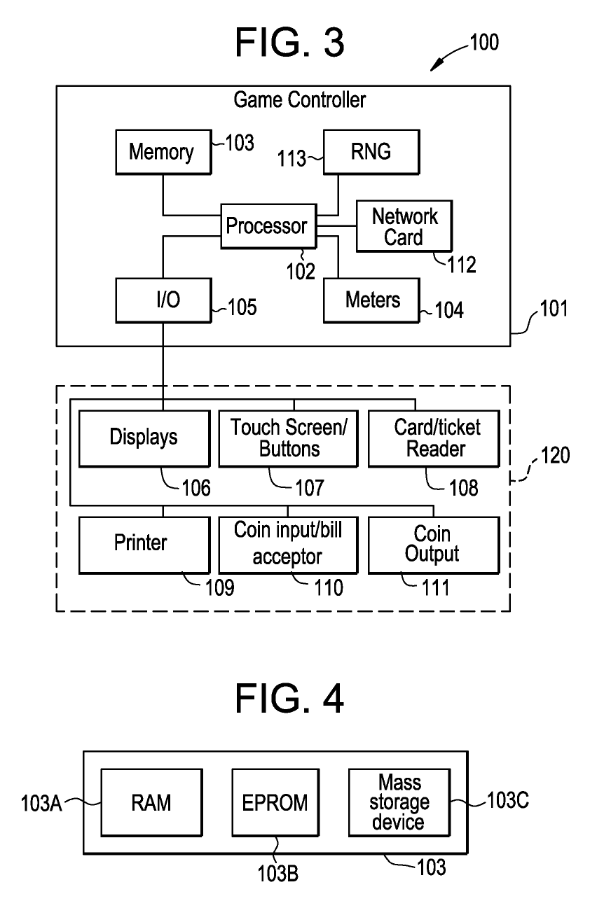

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 include one or more displays 106, a touch screen 107, a card and/or ticket reader 108, a printer 109, a bill acceptor and/or coin input mechanism 110 and a coin output mechanism 111. Additional hardware may be included as part of the gaming machine 100, or hardware may be omitted based on the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

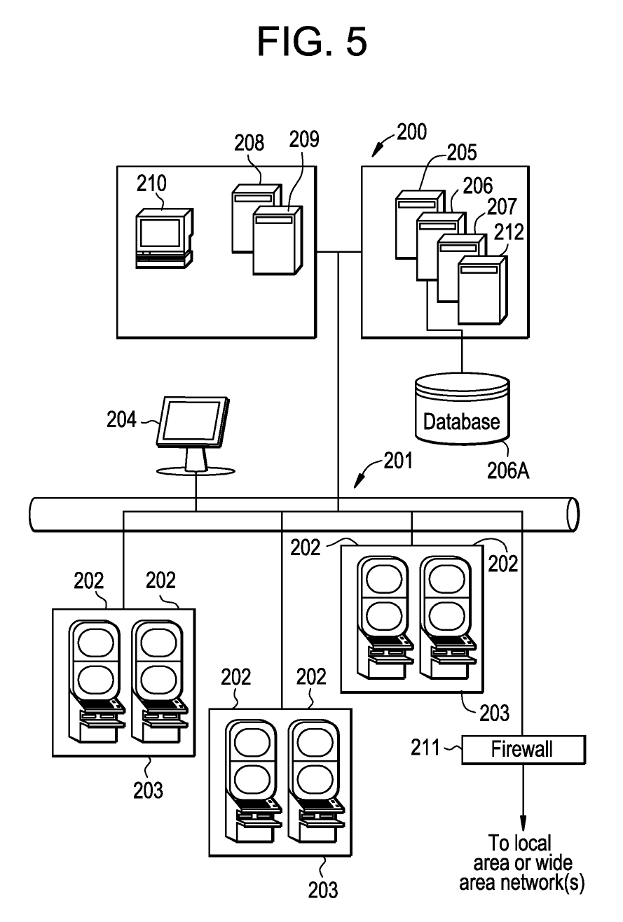

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games based on the terminals.

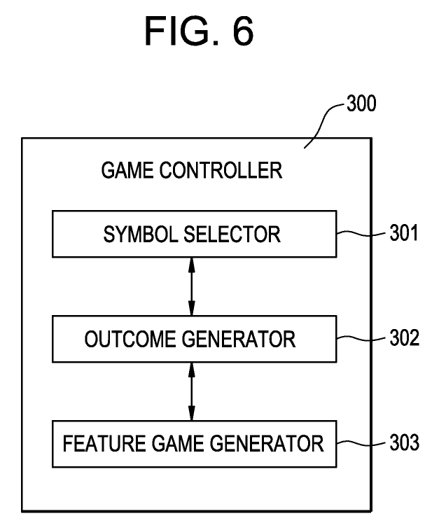

Referring to FIG. 6, the functionality of embodiments of the present invention where the game is played as a feature game in addition to a base game, may be implemented by a game controller 300 having the functional components illustrated. In these embodiments, the functional components are implemented utilizing a processor and memory (such as processor 102 and memory 103 in FIG. 3 or processor 62 and memory 64 in FIG. 1, or the games server 205 of FIG. 5) and associated programming. Other implementations are envisaged. For example, the functional components of FIG. 6 may be implemented in hardware as separate units, or a combination of hardware and software as separate units. Any practical implementation of these functional units may be employed.

Referring to FIG. 6, a game controller 300 includes a symbol selector 301 and an outcome generator 302. The symbol selector 301 and the outcome generator 302 are involved with playing of a base game. When the base game is played, the symbol selector 301 is arranged to select a plurality of symbols from a pre-determined set of available symbols and the outcome generator 302 is arranged to determine a base game outcome based on the selected symbols. In the normal course of a game, these symbols are displayed on the display (54 of FIG. 1, 14 of FIG. 2, 106 of FIGS. 3 and 204 of FIG. 5). The selected symbols in this embodiment are displayed as a plurality of virtual reels on a video display. Alternatively, the display may include a stepper motor and physical reels. Other types of display may be utilized.

The outcome generator 302 is arranged to determine an outcome of the game. In this embodiment, the outcome of the game depends on the selected symbols and may include a win outcome, loss outcome or a feature outcome. Other outcomes may be generated, depending upon the game embodiment. Outcomes may be determined on the basis of symbols appearing in one or more horizontal lines, diagonal lines, or any other pre-determined combination. In this embodiment, the display may have any number of reels. In a typical embodiment, the display has five reels with three reel positions high (when the reels have stopped) shown in the display. This is a typical reel-type display for a gaming machine. It will be appreciated that in other embodiments the number of reel positions may be more or less than three and also the number of reels may be more or less than five. As discussed above, the reels may be virtual reels, generated as a video display from the selected symbols, mechanical reels carrying the symbols and driven by a stepper motor, or any other reel arrangement or emulation.

The symbols may be any symbols. As will be appreciated, many different types of symbols are used in gaming systems. The set of symbols may include standard symbols and function symbols. For example, standard symbols may resemble fruits such as apples, pears and bananas with a win outcome being determined when a pre-determined number of the same fruit appear on a display in the same line, scattered, and so on. A function associated with the function symbol may be a “wild” function wherein display of the function symbols is treated during consideration of the same outcome as any of the standard symbols. Other functions may include scattered functions, multiple functions, repeat when functions, jackpot functions and feature commencement functions. Symbols may also be representations of cards, by which a poker-type card game may be played. The symbols may be any other symbols.

In this embodiment of the invention, the game controller 300 also includes a feature game generator 303. The feature game generator 303 is activated to generate a feature game when the outcome of the base game triggers a feature. The feature may be triggered on the occurrence of a particular symbol combination, on the appearance of a particular feature function symbol, on the basis of random generation, or in other ways.

In this embodiment, when the outcome generator 302 determines that the feature game is to be played as an outcome, the feature game generator 303 is arranged to control the display to display a representation of a feature game input, in this embodiment being the start of a path, and a feature game outcome, in this embodiment being the end of the pathway, and to display the path between the input and outcome.

In this embodiment, the outcome is a feature prize, which may be any prize, including, for example, a multiplier (multiplying the value of a “win” outcome of the base game by a multiplier factor), a jackpot, a jackpot multiplier, a win outcome (e.g. a prize value) or any other outcome. In this embodiment, there are a plurality of outcomes and a plurality of inputs. The player has the opportunity to make a selection of one of the inputs. This gives the player involvement in the feature game. Each input is associated via a path with a unique associated outcome. The player is unaware which input is associated with each outcome until he has made his selection of the input. In an alternative embodiment, the selection is made by the feature game generator 303 and the player is not able to select the input.

In one embodiment, the outcome is determined by the machine on the selection of the input. In another embodiment, the player may need to select the direction that the path takes before the outcome is reached. In an embodiment, the player may be able to select their own direction along the paths provided, to achieve an outcome depending upon their selection of direction.

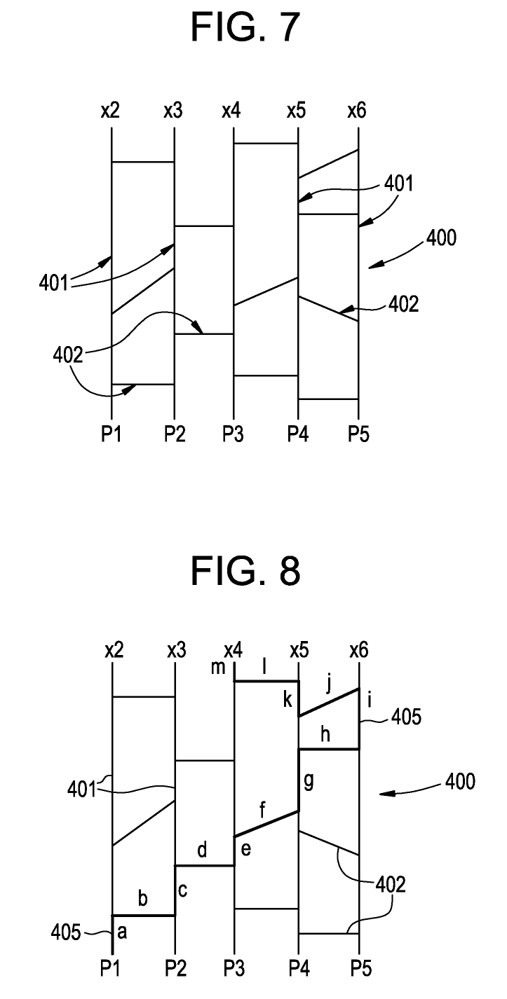

Various examples of feature game displays are illustrated in FIGS. 7 through 11 and are described below. The invention is not limited to the displays illustrated in these figures and there are many variations available on the theme of a plurality of inputs, plurality of outcomes, and paths between the inputs and outputs so that each input is associated with an individual respective output that the pathway connects it to.

In the embodiment shown in FIGS. 7 through 10, the feature game generator is arranged to control the display so that the displayed path is represented as a ladder game format. In a ladder game, inputs and outcomes are connected to each other via pathways which resemble a ladder having risers (sides of the ladder) and rungs (cross bars connecting the sides of the ladder).

Referring to FIG. 7, a display generated by feature game generator 303 is illustrated, being in the form of a ladder game. The ladder game has a plurality of inputs, P1, P2, P3, P4 and P5. It also has a plurality of outcomes, in this example being multiplier outcomes, ×2, ×3, ×4, ×5 and ×6.

The paths, generally designated by reference numeral 400, include a plurality of “ladders” having risers 401 and rungs 402. For clarity not all the risers 401 and 402 have been designated by reference numerals. The risers are the vertical elements in the pathway 400 and the rungs are the cross elements (some being horizontal and some being off-horizontal as illustrated in FIG. 7).

Connection of an input to a respective outcome is via a path defined by the risers 401 and rungs 402 which are interposed between the input and outcome to form the pathway. The path is formed in accordance with pre-determined rules for this embodiment of the feature game. The rules are simple and are that as progress along a pathway is made from the input to the output, every time a join between a rung 402 and riser 401 is reached, the path takes a direction along the rung 402 or riser 401 which joins with the path. This is illustrated in FIG. 8 for the input P1. A thickened line 405 indicates the pathway that is taken between P1 and its associated outcome ×4. Moving along the pathway from P1 to its outcome ×4, the pathway is as follows:

along riser a to rung b

along rung b to riser c

along riser c to rung d

along rung d to riser e

along riser e to rung f

along rung f to riser g

along riser g to rung h

along rung h to riser i

along riser i to rung j

along rung j to riser k

along riser k to rung l

along rung l to riser m

along riser m to output ×4.

The input P1 has a unique outcome (×4). Each of the other inputs P2, P3, P4 and P5 can be seen also to have a unique outcome defined by a unique path connecting the input and outcome.

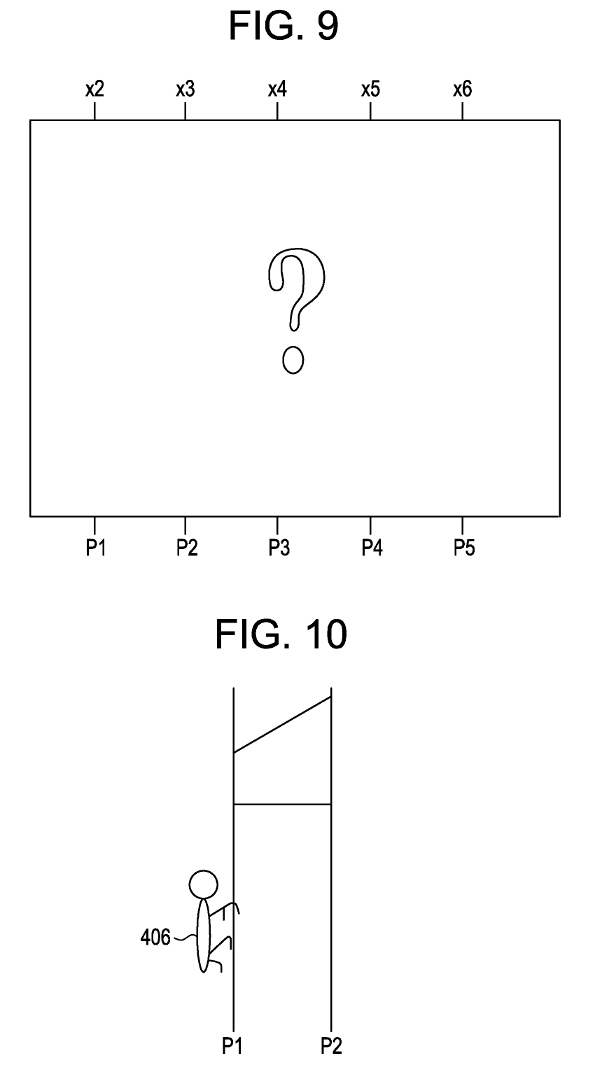

In this embodiment, when the feature game is played, a display appears such as in FIG. 9, which shows the various inputs and also the outcomes (with their associated multiplier prizes), but does not display the paths between. The player therefore does not know which input connects with which outcome. He essentially has to rely on luck and select any input which, in this embodiment as illustrated, has a one in five chance of connecting with a particular output.

When the player has made their selection of a particular input, the ladder display is then revealed and the path between the selected input and achieved outcome is highlighted or otherwise illustrated (such as in FIG. 8). In a variation, the path may be progressively revealed, in order to increase anticipation for the player.

In another variation, as shown in FIG. 10, a graphical character may climb up the pathway to show the pathway between the selected input and the outcome. The graphical character may be any type of character. Here it is shown as a graphical representation of a human.

In this embodiment, the feature game generator 303 is arranged to randomly generate the paths so that the connections between the inputs and the outcomes are not pre-determined.

In another embodiment, the player may be required to select a direction along which he moves. That is, the player may trace his own path in response to direction options presented by the game. This is illustrated by the following example, referring to FIGS. 8 and 9.

### Example

Player is playing a game and triggers a feature.

The display changes to show an image with a start and finish as in FIG. 9.

The player has commenced the feature frame with a total bet of 25 credits which entitled the player to start at P1. Alternatively, the player is entitled to select a starting position.

The available paths are defined but not known to the player. The paths are as shown in FIG. 7. These paths are hidden from view to the player and only completed sections are revealed as selections proceed.

The player is then asked to select a direction up or right. Left is not offered as there is no left path from P1.

The player selects up.

The screen modifies to show a path displayed on the screen in FIG. 8 labelled a.

The player is now asked to select a direction up or right. Left is not offered as there is no left path from this point.

The player selects right.

The screen modifies to show a path displayed on the screen in FIG. 8 labelled b.

The player is now asked to select a direction up or left. Right is not offered as there is no left path from the end of b.

The player selects up.

The screen modifies to show a path displayed on the screen in FIG. 8 labelled c.

The player is now asked to select a direction up or right. Left is not offered as there is no left path from this point.

The player selects right.

The screen modifies to show a path displayed on the screen in FIG. 8 labelled d.

The player is now able to see that part of the screen from the base positions up to path d.

The player is now asked to select a direction up or left. Left is not offered as there is no left path from this point.

The player selects up.

The screen modifies to show a path displayed on the screen in FIG. 8 labelled e.

The player is now asked to select a direction up or right. Left is not offered as there is no left path from this point.

The player selects right.

In this instance, there is no path which moves horizontally to the right; however there is a path which moves diagonally to the right.

The screen modifies to show a path displayed on the screen in FIG. 8 labelled f.

And so on.

The player being constantly asked to select a direction from the available directions and the screen revealing progress as selections are made.

Appropriate sounds will be played with each selection and with each reveal.

In the above example, the player may choose different directions to those selected for the above example, which may a different outcome. In this embodiment, the player traces their own path.

In the above embodiment, the other paths that are available may be revealed in portions as the portions of the path being traced are revealed. In another embodiment, the other paths may not be revealed at all, only the path that the player is tracing.

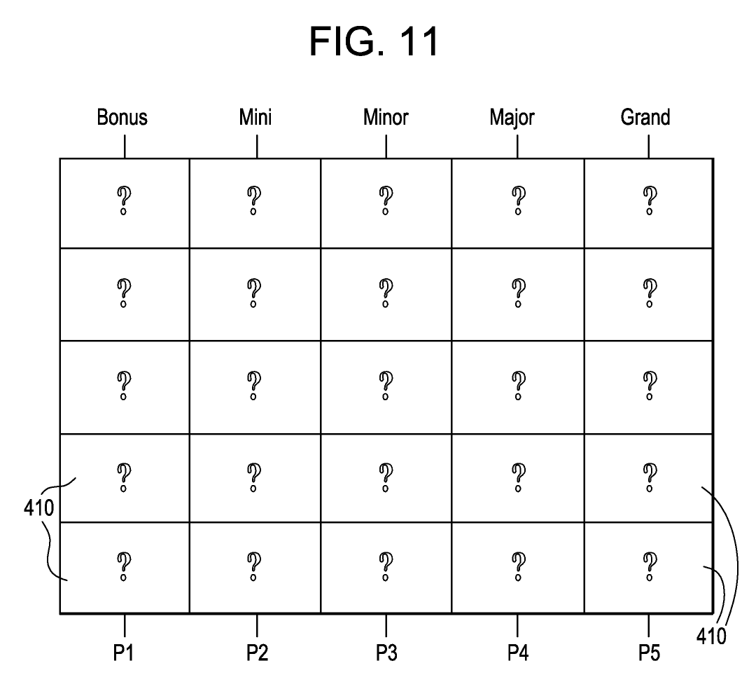

FIG. 11 illustrates an alternative embodiment where the outcomes are four types of jackpot, being “bonus”, “mini”, “minor”, “major”, “grand”. The selection of one of the inputs P1, P2, P3, P4, P5 will lead to one of the outcomes for the jackpot. This particular embodiment may be useful with the Hyperlink™ feature by Aristocrat. In this embodiment, the pathways are progressively revealed (one box 410 at a time, to increase enjoyment and anticipation for the player).

In the above embodiments, each individual input has a respective outcome. In an alternative embodiment, more than one outcome may be associated with a single input or more than one input may be associated with a single outcome. In this alternative embodiment, a single path may diverge into two paths. This could be done, for example, by having two rungs joining together at a riser. Another way that this can be done is by using the embodiment where the player has a choice of direction to take (described above).

This embodiment allows for the possibility of varying the chances of a particular input achieving a particular outcome. For example, more inputs may achieve lower prize outcomes, so that the chances of achieving a higher prize outcome are lower. In an embodiment this may be varied on facts such as amount gambled by a player.

In an embodiment, the inputs that may be selected may depend upon the amount gambled. For example, an input which may lead to a higher value outcome or outcomes may only be selectable if a player gambles an appropriate (higher) amount. In the “example”, for example, the player may only be entitled to select from all starting positions if they bet a certain amount of credits. The same could apply to other embodiments as well.

In the above embodiment, the player manipulates the interface in order to select an input. In an alternative embodiment, the input may be automatically selected by the feature game generator. No player interaction would be required in this case, but the player would still be entertained by observing the machine selection of the input and the pathway.

The path may be progressively revealed, revealed all at once or merely selected and highlighted, or shown in any other way.

In the above embodiments, only a single input is selectable. In other embodiments, the player or the machine may select more than one input, to give the player the chance to receive more than one outcome.

In a further embodiment, a player may be able to view the paths between inputs and outputs prior to making a selection of the input. If a path is made extremely complex, or if a time limit is put on the player selection, this provides an entertaining game as the player may attempt to trace the path through a complex series of paths to an outcome, or may only have a limited time to do it. Even though the path is shown to the player, therefore, there may still be some difficulty in selecting an input to get a desired outcome.

In the above embodiment, the base game is a game which is played by selecting combinations of symbols from a pre-determined set of symbols. The present invention is not limited to play with such a base game. Any type of base game may be played.

The base game may be a numbers game for example, keno or bingo.

Further, in another embodiment, no base game may be required and the game having an input and an output and a path between the input and output may be played as a stand alone game, requiring user selection of an input. In this case, there would be no base game and no display of symbols in the base game. There would merely be a game controller controlling display of inputs, outputs and paths and enabling selection of inputs so that the user can achieve various outcomes.

In the above embodiments, the path is represented as a ladder game format. The invention is not limited to the ladder game format. Other path formats may be utilized. For example mazes between inputs and outputs, or any other type of path. Further, where the path is represented as the ladder game, the risers need not be vertical but could be off-vertical, or zigzag, and the rungs need not be straight but could be bent or in any other form.

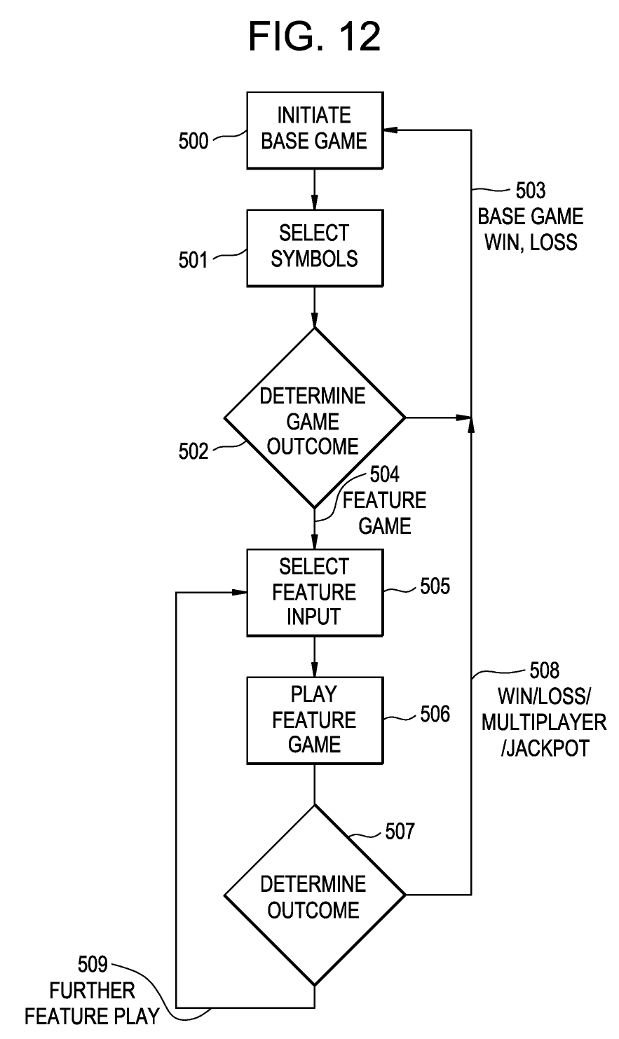

FIG. 12 is a flow diagram illustrating steps in playing of the game embodiment played as a feature game.

At step 500 play of the base game is initiated, usually by player input of coins and actuation of the player interface. The symbol selector 300 selects the symbols from a plurality of symbols (step 501) and the outcome generator 302 determines the game outcome (step 502). The outcome may be a base game win, loss or other base game outcome (503) in which case the player returns to step 500. Whenever the outcome is a feature game (504) a screen such as shown in FIG. 9 is illustrated with a plurality of inputs and outcomes and at step 505 the player selects an input. The feature game is then played (step 506) which may involve revealing randomly generated paths between inputs and the outputs. At step 507 the outcome is determined. The outcome may be a multiplier of a prize already won in the base game, a jackpot or any other outcome (step 508). A further outcome may be a chance to play a further feature game (step 509).

Note that the FIG. 12 process is only one process by which a game in accordance with the present invention may be played. There may be many variations on this.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Method steps associated with certain embodiments may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

1. A gaming system, comprising
a display;
a game controller arranged to determine the outcome of a base game;
and a feature game generator arranged to control play of a feature game, the feature game generator being arranged to determine a feature game outcome, and being arranged to control the display to display a representation of a feature game input and feature game outcome, and a path between the feature game input and outcome.

2. A gaming system in accordance with claim 1, wherein the feature game generator is arranged to enable selection of the feature game outcome from a plurality of available feature game outcomes and to control the display to display representations for the plurality of feature game outcomes.

3. A gaming system in accordance with claim 1, wherein the feature game generator is arranged to enable selection of a feature game input from a plurality of feature game inputs available for selection, and to control the display to display representations of the plurality of feature game inputs.

4. A gaming system in accordance with claim 3, wherein the feature game generator is arranged to enable selection of the feature game outcome from a plurality of available feature game outcomes and to control the display to display representations for the plurality of feature game outcomes, and wherein the feature game generator is arranged to control display of a plurality of paths connecting each input with a respective outcome.

5. A gaming system in accordance with claim 4, wherein the displayed paths are represented as a ladder game format.

6. A gaming system in accordance with claim 1, wherein the feature game generator is arranged to control display of the path such that the path is only revealed after a selection of the feature game input has been made.

7. A gaming system in accordance with claim 6, wherein the feature game generator is arranged to control display of the path such that the path is progressively revealed.

8. A gaming system in accordance with claim 1, wherein the feature game generator is arranged to enable a player to select a direction along the path.

9. A gaming system in accordance with claim 1, wherein the feature game generator is arranged to control the display to display a graphical character moving along the path.

10. A gaming system in accordance with claim 1, wherein the game controller comprises a symbol selector arranged to select a plurality of symbols from a set of symbols, and an outcome generator arranged to determine the base game outcome based on the selected symbols.

11. A method of gaming, comprising the steps of playing a base game;
playing a feature game having a feature game outcome, and displaying a representation of a feature game input and feature game outcome, and a path between the feature game input and outcome.

12. A method in accordance with claim 11, wherein the step of playing the feature game comprises the step of selecting the feature game outcome from a plurality of available feature game outcomes, and the step of displaying a representation comprises the step of displaying representations for the plurality of feature game outcomes.

13. A method in accordance with claim 12, wherein the step of playing the feature game comprises the step of enabling selection of a feature game input from a plurality of feature game inputs available for selection, and the step of displaying a representation comprises the step of displaying representations of the plurality of feature game inputs.

14. A method in accordance with claim 12, wherein the step of displaying the representation comprises the step of displaying a plurality of paths connecting each input with a respective outcome.

15. A method in accordance with claim 13, wherein the displayed paths, are represented as a ladder game format.

16. A method in accordance with claim 11, wherein the step of displaying a representation comprises the step of displaying the paths such that the paths are only revealed after a selection of the feature game input has been made.

17. A method in accordance with claim 16, wherein the step of displaying a representation comprises the step of displaying the path such that the path is progressively revealed.

18. A method in accordance with claim 10, comprising the step of receiving a player selection of a direction along the path, and displaying the direction of the path accordingly.

19. A method in accordance with claim 11, wherein the step of displaying the representation comprises the step of displaying a graphical character moving along the path.

20. A gaming system, comprising
a display,
and a game controller arranged to control play of a game, the game controller being arranged to determine a game outcome, and being arranged to control the display to display a representation of a game input and a game outcome, and a path between the game input and outcome.

21. A method of gaming, comprising the steps of;
playing a game having a game outcome, and displaying a representation of game input and a game outcome, and a path between the game input and outcome.

22. A computer readable medium including a computer program, the computer program comprising instructions for controlling a computer to implement a system comprising:
a display;
a game controller arranged to determine the outcome of a base game;
and a feature game generator arranged to control play of a feature game, the feature game generator being arranged to determine a feature game outcome, and being arranged to control the display to display a representation of a feature game input and feature game outcome, and a path between the feature game input and outcome.

23. A computer readable medium including a computer program, the computer program comprising instructions for controlling a computer to implement a system comprising:
a display,
and a game controller arranged to control play of a game, the game controller being arranged to determine a game outcome, and being arranged to control the display to display a representation of a game input and a game outcome, and a path between the game input and outcome.
